(19) United States
(12) Patent Application Publication
(10) Pub. No.: US 2010/0156930 A1
(43) Pub. Date: Jun. 24, 2010

(54) SYNTHETIC DATA TRANSMITTING APPARATUS, SYNTHETIC DATA RECEIVING APPARATUS AND METHOD FOR TRANSMITTING/RECEIVING SYNTHETIC DATA

(75) Inventors: Sang Won GHYME, Daejeon (KR); II-Kwon JEONG, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/470,548

(22) Filed: May 22, 2009

(30) Foreign Application Priority Data
Dec. 22, 2008 (KR) 10-2008-0131762

(51) Int. Cl. G09G 5/00

(52) U.S. Cl. 345/619

(57) ABSTRACT

A synthetic data transmitting apparatus includes: a data conversion unit for converting a three-dimensional model to synthetic data, the synthetic data having a structure allowing the synthetic data to be divided into small-sized unit data capable of being combined again into the synthetic data; a data division unit for dividing the synthetic data into the unit data; and a data transmission unit for transmitting the unit data via a wired/wireless communications network. A synthetic data receiving apparatus includes: a data combining unit for receiving the unit data of the synthetic data and combining the unit data into the synthetic data; a data controller for controlling a level of detail of the combined synthetic data; and a data output unit for outputting the combined synthetic data according to the level of detail.

### CROSS-REFERENCE(S) TO RELATED APPLICATION(S)

The present invention claims priority of Korean Patent Application No. 10-2008-0131762, filed on Dec. 22, 2008, which is incorporated herein by reference.

### FIELD OF THE INVENTION

The present invention relates to computer graphics; and, more particularly, to a synthetic data transmitting apparatus, a synthetic data receiving apparatus and a method for transmitting/receiving synthetic data including 3D (three-dimensional) models, motion data and the like, wherein the synthetic data has a structure capable of being divided into small-sized unit data and combined again, to thereby flexibly maintain data transmission quality when contents are broadcasted or transmitted via various wired/wireless communications networks.

### BACKGROUND OF THE INVENTION

Image contents having fixed resolution are not suitable for current situation in which images are displayed on from mini displays to ultra high-definition displays. Moreover, since the image contents have a low degree of freedom in representation, it is difficult to flexibly transmit or broadcast the image contents via from narrow to wide bandwidth wired/wireless communications networks.

Synthetic data relating to existing 3D model and motion data is an alternative to solve the above-described problems.

However, standardization of the synthetic data has not yet been successful, which means that distribution of synthetic data has not been activated. Major reasons why the standardization of the synthetic data is unsuccessful, poor Internet networks, poor terminal devices and a heavy data structure of the synthetic data.

High-performance devices having high computational speed are needed to appropriately represent synthetic data. However, performance of devices has not yet been improved to reach a required level. Furthermore, a flexible structure of the synthetic data is needed to facilitate data exchange among users. However, data structures of VRML (Virtual Reality Mark-up Language) and X3D (Extensible 3D) resulting from the recent standardization work are too complicated and heavy to meet the requirement.

On the other hand, synthetic data having an exclusive data structure is practically used in computer game field. However, such practical use is not extended to other fields due to closed characteristics of the computer game field. Although infrastructure has been prepared as appearance of a graphic accelerating board and high-speed communications networks, research and technology on the standardization of the synthetic data to lead the market and explosive distribution of the synthetic data based on the infrastructure has not yet been developed sufficiently.

Synthetic data based contents are characterized in that a bundle of all needed resources are sent to a user and the user processes the received bundle of resources. In order to display the synthetic data, rendering and rasterizing processes need to be performed. In general, the rendering process needs a long computation time, which results in difficulty in representing complicated data in real-time.

That is, the data structures of the synthetic data in the conventional standardization is heavy and cannot be divided into small-sized units, which results in high transmission load. Further, the data structures are inappropriate to transmit or broadcast contents via wired/wireless communications networks.

### SUMMARY OF THE INVENTION

In view of the above, the present invention provides a synthetic data transmitting apparatus, a synthetic data receiving apparatus and a method for transmitting/receiving synthetic data, wherein the synthetic data has a structure capable of being divided into small-sized unit data and combined again, to thereby flexibly maintain data transmission quality when contents are broadcasted or transmitted via various wired/wireless communications networks.

In accordance with a first aspect of the present invention, there is provided a synthetic data transmitting apparatus, the apparatus including:

a data conversion unit for converting a three-dimensional model to synthetic data, the synthetic data having a structure allowing the synthetic data to be divided into small-sized unit data capable of being combined again into the synthetic data;

a data division unit for dividing the synthetic data into the unit data; and

a data transmission unit for transmitting the unit data via a wired/wireless communications network.

Preferably, each of the unit data is contour data of the three-dimensional model.

Preferably, each of the unit data is motion data of the three-dimensional model.

In accordance with a second aspect of the present invention, there is provided a synthetic data receiving apparatus, wherein a transmitting-side converts a three-dimensional model into synthetic data having a structure allowing the synthetic data to be divided into small-sized unit data capable of being combined again into the synthetic data, divides the synthetic data into the unit data and transmits the unit data via a wired/wireless communications network, the apparatus including:

a data combining unit for receiving the unit data of the synthetic data and combining the unit data into the synthetic data;

a data controller for controlling a level of detail of the combined synthetic data; and

a data output unit for outputting the combined synthetic data according to the level of detail.

Preferably, the data output unit displays the combined synthetic data as the three-dimensional model.

The synthetic data receiving apparatus may further includes: a data monitoring unit for monitoring whether the unit data is received, whether the unit data is lost and whether the received unit data is deformed; and a data restoring unit for restoring the lost and deformed unit data.

Preferably, the data restoring unit includes: a data loss restoring unit for restoring the lost unit data; and a data deformation restoring unit for restoring the deformed unit data.

Preferably, the data loss restoring unit restores the lost unit data by estimating the lost unit data through Kalman-filtering.

Preferably, the data loss restoring unit restores the lost unit data by requesting the transmitting-side to re-transmit the lost unit data.

Preferably, the data deformation restoring unit restores the deformed unit data by comparing location and size information of the deformed unit data with those of other received unit data.

Preferably, if a specific number of consecutive deformed unit data is received, the data deformation restoring unit forcibly validates the finally received deformed unit data.

The synthetic data receiving apparatus may further include a data transmission controller for controlling a data transmission speed of the synthetic data by requesting the transmitting-side to change the data transmission speed.

In accordance with a third aspect of the present invention, there is provided a method for transmitting/receiving synthetic data, the method including:

converting, at a transmitting-side, a three-dimensional model to synthetic data, the synthetic data having a structure allowing the synthetic data to be divided into small-sized unit data capable of being combined again into the synthetic data;

dividing, at the transmitting-side, the synthetic data into the unit data;

transmitting, at the transmitting-side, the unit data via a wired/wireless communications network;

receiving, at a receiving-side, the unit data of the synthetic data transmitted via the wired/wireless communications network;

combining, at the receiving-side, the received unit data into the synthetic data;

controlling, at the receiving-side, a level of detail of the combined synthetic data; and

outputting, at the receiving-side, the combined synthetic data according to the level of detail

The method may further include: monitoring, at the receiving-side, whether the unit data is received, whether the unit data is lost and whether the received unit data is deformed; and restoring, at the receiving-side, the lost and deformed unit data.

Preferably, said restoring the lost and deformed unit data includes: restoring the lost unit data; and restoring the deformed unit data.

Preferably, said restoring the lost unit data is performed by estimating the lost unit data through Kalman-filtering.

Preferably, said restoring the lost unit data is performed by requesting the transmitting-side to re-transmit the lost unit data.

Preferably, said restoring the deformed unit data is performed by comparing location and size information of the deformed unit data with those of other received unit data.

Preferably, if a specific number of consecutive deformed unit data is received, said restoring the deformed unit data is performed by forcibly validating the finally received deformed unit data.

The method may further include controlling, at the receiving-side, a data transmission speed of the synthetic data by requesting the transmitting-side to change the data transmission speed.

According to the present invention, synthetic data to be transmitted is divided into small-sized unit data at transmitting part, and combined again into the synthetic data at receiving part, thereby flexibly maintaining data transmission quality when contents are broadcasted or transmitted via various wired/wireless communications networks

### BRIEF DESCRIPTION OF THE DRAWINGS

The above features of the present invention will become apparent from the following description of embodiments, given in conjunction with the accompanying drawings, in which:

FIG. 1 illustrates a block diagram of a synthetic data transmitting apparatus and a synthetic data receiving apparatus in accordance with an embodiment of the present invention; and

FIG. 2 illustrates a flowchart of a synthetic data transmitting/receiving method performed between the apparatuses of FIG. 1.

### DETAILED DESCRIPTION OF THE EMBODIMENTS

Hereinafter, embodiments of the present invention will be described in detail with reference to the accompanying drawings, which form a part hereof.

Synthetic data may include 3D mesh model data, motion data, sentence data and other data, e.g., image information, touch (tactile) information, smell (olfactory) information and the like.

The synthetic data contains contents same to the 3D mesh model data, motion data and sentence data, but has a different structure allowing the synthetic data to be decomposed/composed in small-sized units. Each unit data can be not only represented solely but also represented in a more complete form when composed with other unit data.

Decomposing/composing synthetic data in small-sized units are to divide the synthetic data in smaller data than the synthetic data in size and combine again the divided synthetic data. To this end, there are many methods including a method of decomposing/composing synthetic data in Lego information, a method of decomposing/composing synthetic data in contour information, a method of dividing/progressing synthetic data by time and the like.

The method of decomposing/composing synthetic data in Lego information is to divide/combine synthetic data spatially. The original synthetic data cannot be analogized by using single divided Lego information, but can be completed by combining a number of Lego information to be spatially stacked one by one. For example, a desk model is divided into individual Lego information such as a top panel, a drawer and the like, and an animal model having one mesh is divided into arms, legs and the like.

The method of decomposing/composing synthetic data in contour information is to divide/combine synthetic data topologically. In this method, an outer shape of the original synthetic data can be approximately analogized by using single divided contour information. The original synthetic data is clearly completed by combining a number of contour information to be topologically overlapped. For example, if a human model has a point mesh and each contour information is defined as a set of points being randomly selected from the point mesh, each contour information is visualized as a point cloud in an approximate human shape. A Voxel method may be used in the same manner.

The method of dividing/progressing synthetic data by time is to regard synthetic data as a time continuum. Time continuance synthetic data is divided into synthetic data at each unit time and combined again a number of the synthetic data at each time to complete the time continuance synthetic data. For example, motion data is divided into unit information, i.e., a number of detailed information on a specific skeleton construction, by unit time, and animation of a mesh model may be divided into unit information, i.e., a detailed mesh model by unit time.

Synthetic data is visualized according to a level of detail which depends on combining method of the synthetic data divided into small-sized units. According to the level of detail, combined synthetic data can represent a shape same to that of the original synthetic data, or a shape less detailed than that of the original synthetic data.

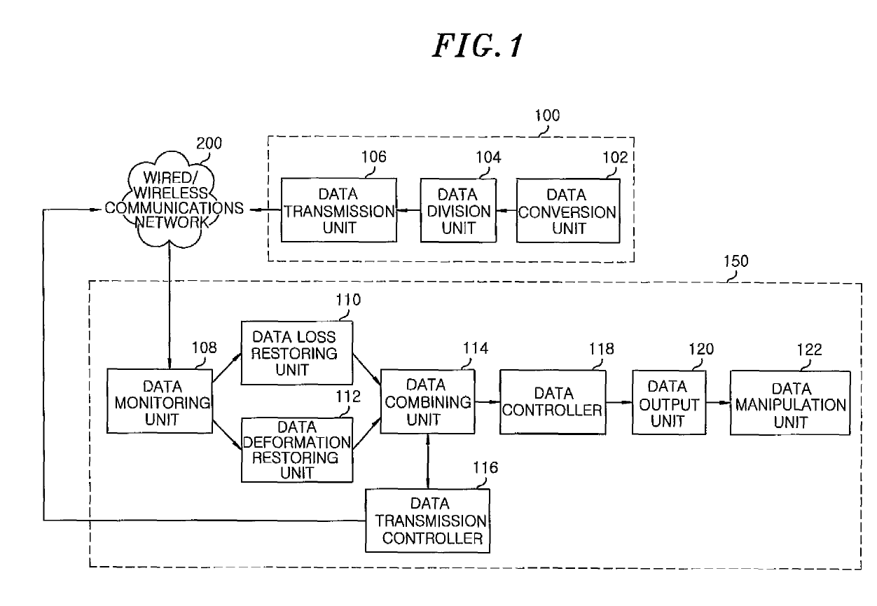

FIG. 1 illustrates a block diagram of a synthetic data transmitting apparatus 100 and a synthetic data receiving apparatus 150 in accordance with an embodiment of the present invention. Below, operation of each part of the synthetic data transmitting apparatus 100 and the synthetic data receiving apparatus 150 will be described in detail with reference to FIG. 1.

For ease of explanation, in FIG. 1, a terminal transmitting synthetic data, i.e, a left side part of a wired/wireless communications network 200, includes the synthetic data transmitting apparatus 100 only and a terminal receiving synthetic data, i.e, a right side part of a wired/wireless communications network 200, includes the synthetic data receiving apparatus 150 only. However, it should be noted that a terminal may include both the synthetic data transmitting apparatus 100 and the synthetic data receiving apparatus 150.

The synthetic data transmitting apparatus 100 includes a data conversion unit 102, a data division unit 104 and a data transmission unit 106.

When transmitting synthetic data, the data conversion unit 102 converts a 3D mesh model to synthetic data having a structure capable of being divided into small-sized units and combined again. The data division unit 104 divides the synthetic data converted by the data conversion unit 102 into small-sized units (hereinafter, referred to as “unit data”). The data transmission unit 106 transmits the unit data divided by the data division unit 104 to a terminal receiving the synthetic data via the wired/wireless communications network 200.

The synthetic data receiving apparatus 150 includes a data monitoring unit 108, a data loss restoring unit 110, a data deformation restoring unit 112, a data combining unit 114, a data transmission controller 116, a data controller 118, a data output unit 120 and a data manipulation unit 122.

When receiving synthetic data, the data monitoring unit 108 checks whether the synthetic data is received via the wired/wireless communications network 200 and whether one or more unit data of the received synthetic data are lost or deformed.

The data loss restoring unit 110 restores unit data lost during the transmission via the wired/wireless communications network 200. If the number of lost unit data of spatially or topologically divided synthetic data is less than a specific level, the data loss restoring unit 110 ignores the loss. However, if the number of lost unit data spatially or topologically divided synthetic data is equal to or greater than the specific level, the data loss restoring unit 110 requests the terminal transmitting the synthetic data to re-transmit the lost unit data. Further, if the synthetic data has been time-divided, the lost unit data can be estimated through Kalman-filtering.

The data deformation restoring unit 112 restores the unit data deformed during the transmission via the wired/wireless communications network 200. If unit data of spatially or topologically divided synthetic data is deformed during the transmission via the wired/wireless communications network 200, the data deformation restoring unit 112 restores the deformed unit data by comparing location and size information of the deformed unit data with those of other received unit data.

Further, if the synthetic data has been time-divided, the data deformation restoring unit 112 compares topological difference between the unit data and previously received unit data. If the topological difference is within a specific error range, the unit data is considered to be valid unit data. If the number of consecutive invalid, i.e., deformed, unit data is greater than a specific level, the data deformation restoring unit 112 forcibly validates the finally received unit data among the consecutive invalid unit data.

The data combining unit 114 combines the unit data into the original synthetic data. The data controller 118 controls a level of detail of the synthetic data combined by the data combining unit 114. The data output unit 120 outputs the synthetic data combined by the data combining unit 114 according to the level of detail controlled by the data controller 118. For example, the data output unit 120 displays a 3D model and/or outputs a sentence in voice via a speaker.

The data manipulation unit 122 manipulates a location, direction, size and the like of the 3D model output by the data output unit 120 or manipulates volume, tone and the like of the voice of the sentence output by the data output unit 120.

The data transmission controller 116 controls a data transmission speed via the wired/wireless communications network 200 by requesting the terminal transmitting the synthetic data to change a data transmission speed. If the transmission speed does not reach a data combining speed in the data combining unit 114, output of the synthetic data via the data output unit 120 discontinues in terms of time. The data transmission controller 116 controls the data transmission speed to solve the above-described problem.

As describe above, at a transmitting part, synthetic data is divided into small-sized unit data and transmitted via a wired/wireless communications network. At a receiving part, the unit data received via the wired/wireless communications network is combined spatially/topologically or by time.

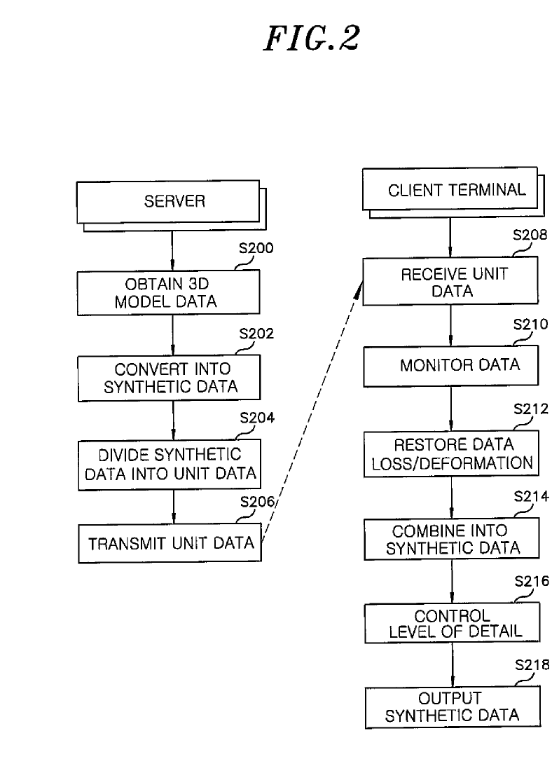

FIG. 2 illustrates a flowchart of a synthetic data transmitting/receiving method performed in the apparatus of FIG. 1. The method will be described in detail with reference to FIGS. 1 and 2.

Suppose web-shopping via the Internet based on the existing image and video data. First, products on sale are represented as a small image thumbnail. When a purchaser selects a product, front-view, side-view and top-view photographs of the product are provided along with explanatory sentences for the product. However, the purchaser cannot see overall appearance of the product and cannot predict a size thereof. Moreover, there is a problem in that colors of the product in the photographs are different from those of the real product due to lighting effect and the like.

Below, the method for transmitting/receiving synthetic data will be described with an example of web-shopping via the Internet based on synthetic data.

First, a seller, i.e., a server side part in FIG. 2, obtains 3D model data on a product via a 3D scanner (step S200), and then the seller converts via the data conversion unit 102 the 3D model data into synthetic data, e.g., data on contour information, having a structure capable of being divided into small-sized units and combined again (step S202). The seller divides the synthetic data into unit data via the data division unit 104 (step S204). The seller may further prepare sentence data for explaining the product. The seller uploads to a web-shopping window the contour information converted into the synthetic data as a thumbnail of the product.

When a purchaser, i.e., a client terminal side part in FIG. 2, selects the product via the thumbnail in a thumbnail list on the web-shopping window, a request for transmitting the unit data of the product is delivered to the server. In response to the transmission request, the data transmission unit 106 in the server starts transmitting the prepared unit data to the client terminal via the wired/wireless communications network 200, (step S206).

The synthetic data receiving apparatus 150 in the client terminal receives the unit data (step S208). The data monitoring unit 108 monitors the received unit data to determine whether one or more unit data of the synthetic data are lost or deformed (step S210). Subsequently, the data loss restoring unit 110 and the data deformation restoring unit 112 restore the lost and deformed unit data, respectively (step S212). The data combining unit 114 combines the unit data into the original synthetic data (step S214). Subsequently, the data controller 118 controls a level of detail of the synthetic data (step S216), and the data output unit 120 displays the synthetic data according to the level of detail (step S218).

When the purchaser first selects the product, the purchaser can see only approximate contour of the product. However, as time goes by, the contour of the product gradually becomes clear and the purchaser can finally see the complete synthetic data when receiving all unit data. When using the data manipulation unit 122, the purchaser can see an outer appearance, size, color information under different lighting conditions and the like before the completion of receiving the unit data. Furthermore, the purchaser may cancel the selection of the product whose unit data are being transmitted, and return to the thumbnail list of products. When the purchaser likes the product, the purchaser can receive full unit data of the product and carefully review the product.

The information output via the data output unit 120 is not restricted to the contour information, but can be sentence data for explaining the product which can be output in voice. When the purchaser likes the product, the purchaser may pay for the product immediately to request delivery of the product. Further, when the product is a figure, a mechanical part of a toy car or the like, the purchaser may print the synthetic data of the product via a 3D printer.

Difference between transmission speed and combining speed of the unit data can be caused due to channel state of the wired/wireless communications network, which degrades quality of the combined synthetic data. In order to solve the problem, the data controller 118 controls a level of detail of the synthetic data combined by the data combining unit 114. Further, in case of full duplex communications, the data transmission controller 116 may control a data transmission speed via the wired/wireless communications network 200 by requesting the server transmitting the synthetic data to change the data transmission speed.

While the invention has been shown and described with respect to the embodiments, it will be understood by those skilled in the art that various changes and modification may be made without departing from the scope of the invention as defined in the following claims.

What is claimed is:

1. A synthetic data transmitting apparatus, the apparatus comprising:
a data conversion unit for converting a three-dimensional model to synthetic data, the synthetic data having a structure allowing the synthetic data to be divided into small-sized unit data capable of being combined again into the synthetic data;
a data division unit for dividing the synthetic data into the unit data; and
a data transmission unit for transmitting the unit data via a wired/wireless communications network.

2. The synthetic data transmitting apparatus of claim 1, wherein each of the unit data is contour data of the three-dimensional model.

3. The synthetic data transmitting apparatus of claim 1, wherein each of the unit data is motion data of the three-dimensional model.

4. A synthetic data receiving apparatus, wherein a transmitting-side converts a three-dimensional model into synthetic data having a structure allowing the synthetic data to be divided into small-sized unit data capable of being combined again into the synthetic data, divides the synthetic data into the unit data and transmits the unit data via a wired/wireless communications network, the apparatus comprising:
a data combining unit for receiving the unit data of the synthetic data and combining the unit data into the synthetic data;
a data controller for controlling a level of detail of the combined synthetic data; and
a data output unit for outputting the combined synthetic data according to the level of detail.

5. The synthetic data receiving apparatus of claim 4, wherein the data output unit displays the combined synthetic data as the three-dimensional model.

6. The synthetic data receiving apparatus of claim 4, further comprising:
a data monitoring unit for monitoring whether the unit data is received, whether the unit data is lost and whether the received unit data is deformed; and
a data restoring unit for restoring the lost and deformed unit data.

7. The synthetic data receiving apparatus of claim 6, wherein the data restoring unit includes:
a data loss restoring unit for restoring the lost unit data; and
a data deformation restoring unit for restoring the deformed unit data.

8. The apparatus for receiving synthetic data of claim 7, wherein the data loss restoring unit restores the lost unit data by estimating the lost unit data through Kalman-filtering.

9. The apparatus for receiving synthetic data of claim 7, wherein the data loss restoring unit restores the lost unit data by requesting the transmitting-side to re-transmit the lost unit data.

10. The synthetic data receiving apparatus of claim 7, wherein the data deformation restoring unit restores the deformed unit data by comparing location and size information of the deformed unit data with those of other received unit data.

11. The synthetic data receiving apparatus of claim 7, wherein if a specific number of consecutive deformed unit data is received, the data deformation restoring unit forcibly validates the finally received deformed unit data.

12. The synthetic data receiving apparatus of claim 4, further comprising a data transmission controller for controlling a data transmission speed of the synthetic data by requesting the transmitting-side to change the data transmission speed.

13. A method for transmitting/receiving synthetic data, the method comprising:
converting, at a transmitting-side, a three-dimensional model to synthetic data, the synthetic data having a structure allowing the synthetic data to be divided into small-sized unit data capable of being combined again into the synthetic data;
dividing, at the transmitting-side, the synthetic data into the unit data;
transmitting, at the transmitting-side, the unit data via a wired/wireless communications network;
receiving, at a receiving-side, the unit data of the synthetic data transmitted via the wired/wireless communications network;
combining, at the receiving-side, the received unit data into the synthetic data;
controlling, at the receiving-side, a level of detail of the combined synthetic data; and
outputting, at the receiving-side, the combined synthetic data according to the level of detail

14. The method of claim 13, further comprising:
monitoring, at the receiving-side, whether the unit data is received, whether the unit data is lost and whether the received unit data is deformed; and
restoring, at the receiving-side, the lost and deformed unit data.

15. The method of claim 14, wherein said restoring the lost and deformed unit data includes:
restoring the lost unit data; and
restoring the deformed unit data.

16. The method of claim 15, wherein said restoring the lost unit data is performed by estimating the lost unit data through Kalman-filtering.

17. The method of claim 15, wherein said restoring the lost unit data is performed by requesting the transmitting-side to re-transmit the lost unit data.

18. The method of claim 15, wherein said restoring the deformed unit data is performed by comparing location and size information of the deformed unit data with those of other received unit data.

19. The method of claim 15, wherein if a specific number of consecutive deformed unit data is received, said restoring the deformed unit data is performed by forcibly validating the finally received deformed unit data.

20. The method of claim 13, further comprising controlling, at the receiving-side, a data transmission speed of the synthetic data by requesting the transmitting-side to change the data transmission speed.
